(19) United States
(12) Patent Application Publication
(10) Pub. No.: US 2018/0202311 A1
(43) Pub. Date: Jul. 19, 2018

(54) METHOD FOR CONTROLLING A WASTE-HEAT UTILIZATION SYSTEM FOR A MOTOR VEHICLE

(71) Applicants: AVL LIST GMBH, Graz (AT); IVECO S.P.A., TORINO (IT); FPT INDUSTRIAL S.P.A., TORINO (IT)

(72) Inventors: Klemens Neunteufl, Graz (AT); Oswald Lackner, Fehring (AT); Gerald Gradwohl, Graz (AT); Fabio Cococcetta, Zürich (CH); Ivan CALAON, Torino (IT); Michael GLENSVIG, Graz (AT)

(73) Assignees: AVL LIST GMBH, GRAZ (AT); IVECO S.P.A., TORINO (IT); FPT INDUSTRIAL S.P.A., TORINO (IT)

(21) Appl. No.: 15/743,478

(22) PCT Filed: Jul. 11, 2016
(86) PCT No.: PCT/AT2016/050248

§ 371 Date: Jan. 10, 2018

(30) Foreign Application Priority Data
Jul. 10, 2015 (AT) A 50609/2015

(51) Int. Cl. F01D 17/10; F01N 5/04; F02B 41/10; F01K 23/06; F01K 23/14

(52) U.S. Cl. CPC F01D 17/105; F01N 5/04; F05D 2220/62; F01K 23/065; F01K 23/14; F02B 41/10

(57) ABSTRACT

The invention relates to a method for controlling a waste-heat utilization system (20) for a motor vehicle driven by an internal combustion engine (10) by means of a drive train (13), wherein the waste-heat utilization system (20) has at least one expander (22), at least one evaporator (21), and at least one pump (24) for an operating medium, in particular ethanol. At least the evaporator (21) is arranged in the region of the exhaust gas system (11) of the internal combustion engine (10). The expander (22), which can be operated in several operating modes, performs work in at least one operating mode. One operating mode of at least two operating modes (1, 2, 4, 5) of the expander (22) is selected by a control device (30) on the basis of at least one input variable from the group of expander rotational speed (n), gear information (GI), coasting information (CI), and pressure (p₁, p₂) and temperature (T₁, T₂) of the operating medium upstream or downstream of the expander (22) and the expander (22) is operated in said operating mode. A first operating mode (1) is associated with a warm-up phase of the expander (22) and a second operating mode (2) is associated with a normal operating phase of the expander (22). The bypass valve (26) is opened in the first operating mode (1) and closed in the second operating mode. The second operating mode (2) is selected if the pressure (p₂) and/or the temperature (T₂) of the operating medium downstream of the expander (22) exceeds a defined value.

The invention relates to a method for controlling a waste heat utilization system for a motor vehicle driven by an internal combustion engine via a drive train, wherein the waste heat utilization system comprises at least one expander, at least one evaporator and at least one pump for an operating medium, in particular ethanol, and wherein at least the evaporator is disposed in the region of the exhaust gas system of the internal combustion engine, wherein the expander which can be operated in several operating modes delivers work in at least one operating mode and wherein on the basis of at least one input quantity from the group expander speed, gear information, coasting information, pressure and temperature of the operating medium upstream of the expander and/or pressure and temperature downstream of the expander, respectively one operating mode is selected from at least two operating modes of the expander by the control device, and the expander is operated in this operating mode, preferably by triggering at least one bypass valve of the expander disposed in a bypass flow path of the expander.

The invention further relates to a waste heat utilization system for a vehicle driven by an internal combustion engine via a drive train, comprising a control device for controlling the waste heat utilization system, wherein the waste heat utilization system comprises at least one expander which can transmit a torque to the internal combustion engine and which can be bypassed via a bypass flow path, at least one evaporator and at least one pump for an operating means, in particular ethanol, and wherein at least the evaporator is disposed in the region of the exhaust gas system of the internal combustion engine.

It is known to utilize waste heat of internal combustion engines. Such devices known as WHR (waste heat recovery) systems convert the waste heat of the exhaust gas of the internal combustion engine into for example mechanical or electrical energy. Such WHR systems are known, for example, from the publications U.S. Pat. No. 8,635,871 A1, US 2011/0209473 A1 or US 2013/0186087 A1.

US 2009/0071156 A1 discloses a waste heat recovery device with a Rankine cycle which comprises a compressor, a heat exchanger, an expander and a condenser. The expander is drive-connected to an electrical machine and can deliver work to this. The expander can be bypassed via a bypass valve and a bypass flow path, whereby the rotational speed of the expander can be regulated depending on the degree of overheating of the working medium. It is not known from US 2009/071156 A1 that a first operating mode is assigned to a warm-up phase of the expander and a second operating mode is assigned to a normal operating phase of the expander, wherein in the first operating mode the bypass valve is opened and in the second operating mode the bypass valve is closed. Furthermore it is not known from this publication that the second operating mode is selected when the pressure and/or the temperature of the operating medium downstream of the expander exceeds a defined value.

It is the object of the invention to provide an economical, safe and reliable operation of the waste heat utilization system.

According to the invention, this is achieved whereby a first operating mode is assigned to a warm-up phase of the expander and a second operating mode is assigned to a normal operating phase of the expander, and wherein in the first operating mode the bypass flow path is opened and wherein in the second operating mode the bypass flow path is closed, and wherein the second operating mode is selected when the pressure and/or the temperature of the operating means exceeds a defined value downstream of the expander.

In the first operating mode the bypass valve is opened, the starting device is deactivated, The operating medium is thus guided past the expander, with the result that the expander does not generate any torque. In the second operating mode, the bypass valve is closed, the starting device is also deactivated. When the bypass valve is closed, the operating medium flows through the expander with the result that this performs work.

It can further be provided within the framework of the invention that the waste heat utilization system is operated in a fourth operating mode during at least one coasting mode of the vehicle, during at least one warm-up mode of the internal combustion engine and/or at least one engine braking mode of the internal combustion engine. Preferably in the fourth operating mode the bypass flow path is closed in order to deliver torque from the expander to the drive train of the vehicle when the expander is connected to the drive train, whereby the coasting phase of the vehicle can be extended and fuel can be saved. If the expander is connected to an electrical machine, in the fourth operating mode electrical energy can be generated and can be supplied to the electrical system of the vehicle or stored.

Coasting mode is understood as a torque-free mode of the vehicle in which the disengageable clutch between internal combustion engine and transmission is opened to reduce the resistance in the drive train.

Whether a coasting mode of the vehicle is present or not is notified to the control device by the transmission or the disengageable clutch by means of coasting information.

In the first operating mode and/or when the heat utilization system is inactive, the expander is bypassed—with the bypass valve open—via the bypass flow path.

In order to achieve a high efficiency, it is provided within the framework of the invention that the bypass flow path of the expander is only closed when the operating medium of the waste heat utilization system is in an overheated state. When the operating medium of the waste heat utilization system upstream of the expander is in a non-overheated state or when the internal combustion engine is stopped, the bypass flow path is opened.

The invention is described in detail hereinafter with reference to the non-restrictive figures. In the figures schematically:

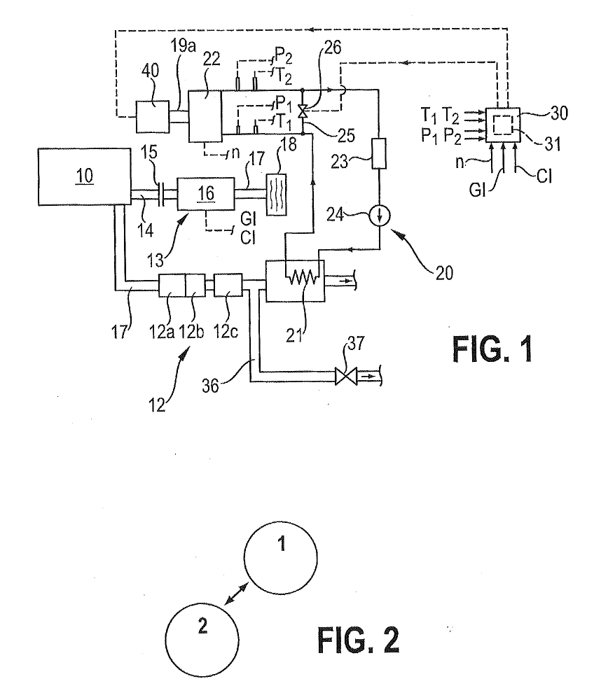

FIG. 1 shows a waste heat utilization system for an internal combustion engine with a control device according to the invention in a first embodiment;

FIG. 2 shows the operating modes of this control device;

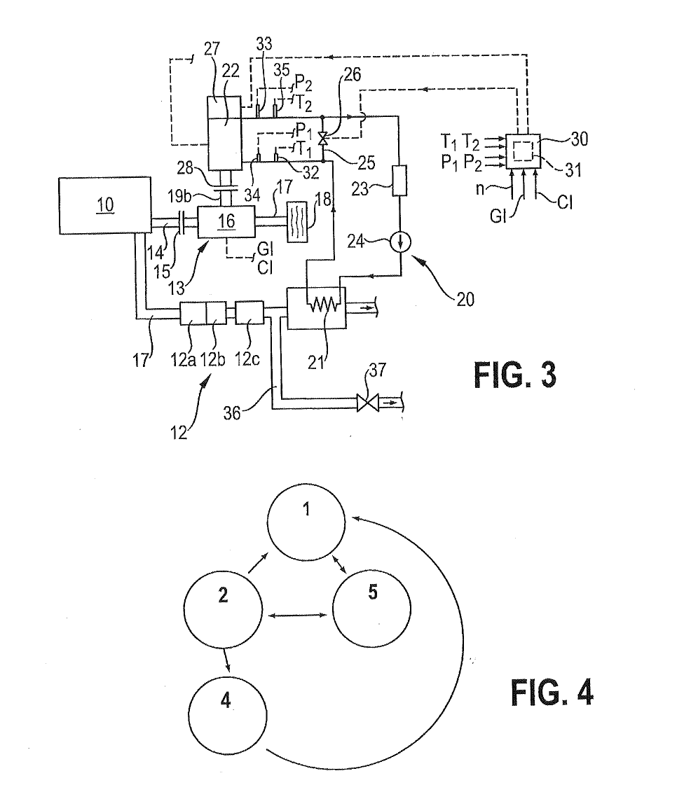

FIG. 3 shows a waste heat utilization system for an internal combustion engine with a control device according to the invention in a second embodiment; and

FIG. 4 shows the operating modes of this device.

In the embodiments shown components having the same function are provided with the same reference numbers.

FIG. 1 and FIG. 3 each show an internal combustion engine 10 with an exhaust gas system 11 in which an exhaust gas after-treatment device 12—for example a diesel oxidation catalyst 12, a diesel particle filter 12b and an SCR catalyst 12c (SCR—selective catalytic reduction)—is arranged. The internal combustion engine 10 has a drive train 13 with a crank shaft 14, a disengageable clutch 15 and a (manual) transmission 16 which acts on the drive shaft 17 of the drive wheels 18.

The internal combustion engine 10 further has a waste heat utilization system 20 for utilizing the exhaust gas values of the exhaust gas system 11 of the internal combustion engine 10. The waste heat utilization system 20 has an evaporator 21 which—in relation to the exhaust gas flow in the exhaust gas system 11—is arranged downstream of the exhaust gas after-treatment device 12 in the region of the exhaust gas system 11. The waste heat utilization system 20 which functions for example according to the organic Rankine cycle (ORC) comprises, downstream of the evaporator 21 in the operating medium circuit, an expander 22 and a condenser 23, as well as a pump 24 for the operating medium. For example, ethanol can be used as operating medium. In order to bypass the expander 22, a bypass line 25 with a bypass valve 26 is provided. The evaporator 21 can be bypassed on the exhaust gas side via a bypass line 36 and a bypass valve 37 if the exhaust gas heat is too high for the evaporator 21 or the system pressure exceeds a defined value or the cooling system is excessively loaded or the waste heat utilization system 20 is in an error mode or in pure engine mode, without engine braking, The bypass valve 37 is triggered depending on at least one of the operating parameters from the group fan power, system pressure, system temperature and mass flow of the operating medium.

A control device 30 is provided for controlling the waste heat utilization system 20, which has a program logic 31 which is configured to select the most suitable operating mode from the plurality of operating modes 1, 2 or 1, 2, 4, 5 for operation of the waste heat utilization system 20. The selection of the most suitable operating mode is made on the basis of at least one of the input variables of the control device 30, namely: expander rotational speed n, gear information GI, coasting information CI, pressure p₁ temperature T₁ of the operating medium upstream of the expander 22 as well as the pressure p₂ and the temperature T₂ of the operating medium downstream of the expander 22. Pressure sensors 32, 33 and temperature sensors 34, 35 are provided upstream and downstream of the expander 22 in the operating medium circuit of the waste heat utilization system 20 to record the parameters pressures p₁, p₂ and temperatures T₁, T₂. The pressure sensors 32, 33 and temperature sensors 34, 35 are connected to the control device 30. The gear information GI and coasting information CI are provided, for example by suitable sensors in the transmission 16 of the control device 30.

In the simple first embodiment shown in FIG. 1, the expander 22 is connected to an electrical machine 40 via a shaft 19a. The electrical machine 40 is connected to the control device 30, with the result that the expander 22 can be started by the electrical machine 40.

The operating modes of this first embodiment are shown in FIG. 2. The following operating modes can be executed with the embodiment shown in FIG. 1:

First operating mode 1 is executed during the warm-up phase of the expander 22; in the operating mode 1 the bypass valve 26 is opened so that the operating medium is guided past the expander 22.

Second operating mode 2: this operating mode 2 is assigned to the normal operation of the expander 22. As soon as the pressure p₂ and/or the temperature T₂ of the operating medium downstream of the expander 22 exceed a defined value or defined values, the operating mode 2 is activated.

Optionally a fourth operating mode can also be driven during coasting operation of the vehicle, wherein electrical energy can be generated by the electrical machine and supplied to the on-board network.

The second embodiment shown in FIG. 3 differs from FIG. 1 in that the expander 22 is integrated in the transmission 16 or is drive-connected to this via a shaft 19b. Optionally a disengageable clutch 28 can be disposed between the transmission 16 and the expander 22.

The operating modes of this first embodiment are shown in FIG. 4. The following operating modes can be executed with the embodiment shown in FIG. 3:

First operating mode 1 is executed during the warm-up phase of the expander 22; in the operating mode 1 the bypass valve 26 is opened so that the operating medium is guided past the expander 22.

Second operating mode 2: this operating mode 2 is assigned to the normal operation of the expander 22. As soon as the pressure p₂ and/or the temperature T₂ of the operating medium downstream of the expander 22 exceed a defined value or defined values, the operating mode 2 is activated.

Fourth operating mode 4: this operating mode 4 is used during the coasting mode, the warm-up mode and/or the engine braking mode of the internal combustion engine 10. In the coasting mode the vehicle travels without transmission of torque between internal combustion engine 10 and drive wheels 18, generally with the disengageable clutch 15 open. The bypass valve 26 is closed in the operating mode 4 in order to transmit torque from the expander 22 to the internal combustion engine 10. As a result—in particular when the disengageable clutch 15 is open—the fuel consumption during idling is reduced and/or the coasting phase of the vehicle is lengthened. If the expander 22 is connected to an electrical machine 40, electrical energy can be generated in the fourth operating mode and supplied to the electrical system of the vehicle or stored.

Fifth operating mode 5: this operating mode 5 is used for starting the expander 22 via an internal or external starting device 27.

Alternatively to this, starting can also take place via a self-starting mechanism of the expander 22 (without the fifth operating mode 5).

In order to avoid the expander 22 being operated at excessive rotational speed and thereby being damaged, the control device 30 provides special safety measures. Thus, the bypass valve 26 is only closed when the operating medium is in an overheated state, i.e. for example when the operating medium ethanol is in the gas phase.

1. A method for controlling a waste heat utilization system for a motor vehicle driven by an internal combustion engine via a drive train, wherein the waste heat utilization system comprises at least one expander, at least one evaporator and at least one pump for an operating means, in particular ethanol, and wherein at least the evaporator is disposed in the region of the exhaust gas system of the internal combustion engine, wherein the expander, which can be operated in several operating modes, delivers work in at least one operating mode and wherein on the basis of at least one input quantity from the group expander speed, gear information, coasting information, pressure and temperature of the operating means upstream of the expander and/or pressure and temperature downstream of the expander, respectively one operating mode is selected from at least two operating modes of the expander by the control device, and the expander is operated in this operating mode, preferably by triggering at least one bypass valve of the expander disposed in a bypass flow path of the expander, wherein a first operating mode is assigned to a warm-up phase of the expander and a second operating mode is assigned to a normal operating phase of the expander, and wherein in the first operating mode the bypass flow path is opened, and wherein in the second operating mode the bypass flow path is closed, and wherein the second operating mode is selected when the pressure and/or the temperature of the operating means exceeds a defined value downstream of the expander.

2. The method according to claim 1, wherein the expander is operated in a fourth operating mode during at least one coasting mode of the vehicle, during at least one warm-up mode of the internal combustion engine and/or at least one engine braking mode of the internal combustion engine.

3. The method according to claim 2, wherein the bypass flow path is closed in the fourth operating mode.

4. The method according to claim 1, wherein the waste heat utilization system is operated in a fifth operating mode during at least one starting phase of the expander.

5. The method according to claim 4, wherein the expander is started by motor operation of an electric machine connected to the expander.

6. The method according to claim 4, wherein the expander is started by transmitting torque from the drive train of the internal combustion engine to the expander.

7. The method according to claim 1, wherein the expander delivers work to an electric machine connected to the expander in at least one operating mode.

8. The method according to claim 1, wherein the expander delivers work to drive train in at least one operating mode.

9. The method according to claim 1, wherein the expander is separated from the auxiliary drive shaft in the first operating mode or when the waste heat utilization system is inactive.

10. The method according to claim 1, wherein the bypass flow path of the expander is closed when the operating means of the waste heat utilization system is in an overheated state.

11. A waste heat utilization system for a vehicle driven by an internal combustion engine via a drive train, comprising a control device for controlling the waste heat utilization system, wherein the waste heat utilization system comprises at least one expander which can transmit a torque to the internal combustion engine and which can be bypassed via a bypass flow path, at least one evaporator and at least one pump for an operating means, in particular ethanol, and wherein at least the evaporator is disposed in the region of the exhaust gas system of the internal combustion engine, wherein the expander, which can be operated in several operating modes, delivers work in at least one operating mode and that on the basis of at least one input quantity from the group expander speed, gear information, coasting information, pressure and temperature of the operating means upstream of the expander and/or pressure and temperature downstream of the expander, respectively one operating mode can be selected from at least two operating modes of the expander by the control device, and the expander can be operated in this operating mode, wherein a first operating mode is assigned to a warm-up phase of the expander and a second operating mode is assigned to a normal operating phase of the expander, and wherein in the first operating mode the bypass flow path is opened and in the second operating mode the bypass flow path is closed, wherein the second operating mode can be selected when the pressure and/or the temperature of the operating means exceeds a defined value downstream of the expander.

12. The waste heat utilization system according to claim 11, wherein a fourth operating mode is assigned to at least one coasting mode of the motor vehicle, at least one warm-up mode of the internal combustion engine and/or at least one engine braking mode of the internal combustion engine.

13. The waste heat utilization system according to claim 11, wherein the expander is drive-connected or can be drive-connected to at least one electric machine.

14. The waste heat utilization system according to claim 11, wherein the expander is drive-connected or can be drive-connected to the drive train.

15. The method according to claim 1, wherein the expander is operated in the selected operating mode by triggering at least one bypass valve of the expander disposed in a bypass flow path of the expander.

16. The waste heat utilization system according to claim 11, wherein the operating means is ethanol.

17. The waste heat utilization system according to claim 11, wherein the expander can be operated in the selected operating mode by triggering at least one bypass valve of the expander disposed in a bypass flow path of the expander.

18. The waste heat utilization system according to claim 12, wherein in the fourth operating mode the bypass flow path can be closed.

19. The waste heat utilization system according to claim 13, wherein in a fifth operating mode assigned to at least one starting phase of the expander, the expander can be started by motor operation of the electric machine.

20. The waste heat utilization system according to claim 14, wherein in a fifth operating mode assigned to at least one starting phase of the expander, the expander can be started by transmitting torque from the drive train to the expander.
